(19) United States
(12) Patent Application Publication
(10) Pub. No.: US 2016/0057926 A1
(43) Pub. Date: Mar. 3, 2016

(54) INTEGRATED JACKSHAFT FOR GRAIN ELEVATORS OF AGRICULTURAL COMBINES

(71) Applicant: DEERE & COMPANY, MOLINE, IL (US)

(72) Inventors: Dennis M. Roe, COAL VALLEY, IL (US); RYAN P. MACKIN, MILAN, IL (US); JUSTIN C. FREEHILL, FENTON, IL (US)

(21) Appl. No.: 14/473,873

(22) Filed: Aug. 29, 2014

(51) Int. Cl. A01D 41/12

(52) U.S. Cl. CPC A01D 41/12

(57) ABSTRACT

A jackshaft and grain elevator arrangement is disclosed for agricultural combines. A grain elevator has a housing, a drive sprocket within the housing, a driven sprocket within the housing, and a chain within the housing. The chain is wrapped around the drive sprocket and the driven sprocket, and a plurality of paddles are attached to the chain. A shaft is fixed to and extends through the drive sprocket to drive rotation of the drive sprocket. A first pulley outside the housing is fixed to the shaft to receive power from an engine of the combine and is configured to transmit that power to the shaft. A second pulley outside the housing is fixed to the shaft to receive power from the shaft and is configured to transmit that power to a first crop processing device.

### CROSS-REFERENCE TO RELATED APPLICATION(S)

Not applicable.

### STATEMENT OF FEDERALLY SPONSORED RESEARCH OR DEVELOPMENT

Not applicable.

### FIELD OF THE DISCLOSURE

This disclosure relates to agricultural combines, including jackshafts for driving various devices included in agricultural combines.

### BACKGROUND OF THE DISCLOSURE

Agricultural combines (or “combines”) are large self-propelled machines that harvest and process crop material. Combines separate grain in the crop material from other portions of the crop material and store the grain in a grain tank. The other portions of the crop material may be stored separately, or they may be spread across the ground.

Agricultural combines are driven by internal combustion engines that propel the agricultural combine over the ground and drive a variety of crop processing devices. Typically, the internal combustion engine is connected to these crop processing devices by belts and chains that connect pulleys and sprockets, respectively. The power from the internal combustion engine must be split and directed to each of these crop processing devices.

In one common arrangement commonly called a “jackshaft” arrangement, the internal combustion engine of the agricultural combine drives a belt or chain which is coupled to and drives a respective pulley or sprocket. This pulley or sprocket drives a shaft (or “jackshaft”) in rotation, thereby transmitting power from the internal combustion engine to the shaft. Other pulleys or sprockets are mounted on the shaft that are respectively connected to the crop processing devices via belts or chains, respectively. The shaft itself is supported on bearings that permit it to rotate when driven by the internal combustion engine.

In this manner, power from the internal combustion engine is divided and is transmitted to several crop processing devices. By providing pulleys and sprockets on the shaft of different sizes, each crop processing device can be driven at a different speed.

One problem with using the common jackshaft arrangement to split the power from the internal combustion engine and then to transmit it to several crop processing devices is the additional space, parts, and associated cost required for the jackshaft.

It would be beneficial to integrate the jackshaft with one of the crop processing devices to reduce the number of parts, to reduce the space occupied by parts within the combine, and to reduce the cost of an agricultural combine.

### SUMMARY OF THE DISCLOSURE

A jackshaft and grain elevator arrangement is disclosed for an agricultural combine.

According to one aspect of the disclosure, a grain elevator has a housing, a drive sprocket disposed within the housing, a driven sprocket disposed within the housing, wherein a chain disposed within the housing is wrapped around the drive sprocket and the driven sprocket, and a plurality of paddles are attached to the chain. A shaft extends through the drive sprocket, wherein the shaft is fixed to the drive sprocket to drive the drive sprocket in rotation. A first pulley is disposed outside the housing, wherein the first pulley is fixed to the shaft to receive power from the internal combustion engine and is configured to transmit that power to the shaft. A second pulley is disposed outside the housing, wherein the second pulley is fixed to the shaft to receive power from the shaft and is configured to transmit that power to a first crop processing device.

In certain embodiments, the first pulley may be disposed on the shaft between the second pulley and the grain elevator. The grain elevator may be disposed on the shaft between the first pulley and the second pulley. The first crop processing device may be selected from the group consisting of a cleaning shoe, a straw spreader, a loading auger, and a tailings elevator. A third pulley may be disposed outside the housing, wherein the third pulley is attached to the shaft to receive power from the shaft and transmit that power to a second crop processing device. The second crop processing device may be selected from the group consisting of a cleaning shoe, a straw spreader, a loading auger, and a tailings elevator. The shaft may be supported for rotation on bearings, wherein the bearings are fixed to opposing sides of the housing. The shaft, the first pulley, the second pulley, and the drive sprocket may rotate about a common rotational axis.

According to another aspect of the disclosure, a grain elevator has a housing, a drive sprocket disposed within the housing, a driven sprocket disposed within the housing, and a chain disposed within the housing, wherein the chain is wrapped around the drive sprocket and the driven sprocket, and a plurality of paddles or buckets are attached to the chain. A shaft extends through the drive sprocket, wherein the shaft is fixed to the drive sprocket to drive the drive sprocket in rotation. An input wheel is disposed outside the housing, wherein the input wheel is attached to the shaft to receive power from the internal combustion engine and transmit that power to the shaft. A first output wheel is disposed outside the housing, wherein the first output wheel is attached to the shaft to transmit power from the shaft to a crop processing device.

In certain embodiments, the input wheel may be disposed on the shaft between the first output wheel and the elevator. The elevator may be disposed on the shaft between the input wheel and the first output wheel. The crop processing device may be selected from the group consisting of a cleaning shoe, a straw spreader, a loading auger, and a tailings elevator. A third pulley may be disposed outside the housing, wherein the third pulley is attached to the shaft to receive power from the shaft and transmit that power to a second crop processing device. The second crop processing device may be selected from the group consisting of a cleaning shoe, a straw spreader, a loading auger, and a tailings elevator. The shaft may be supported for rotation on bearings, wherein the bearings are fixed to opposing sides of the housing. The shaft, the drive sprocket, the input wheel, and the first output wheel may all rotate about a common rotational axis.

The details of one or more embodiments are set forth in the accompanying drawings and the description below. Other features and advantages will become apparent from the description, the drawings, and the claims.

### BRIEF DESCRIPTION OF THE DRAWINGS

FIG. 1 is a side view of an example agricultural combine with a grain elevator;

FIG. 2 is a perspective view of various devices of the agricultural combine of FIG. 1, including a grain elevator with an integrated jackshaft assembly, taken from an opposite side of the combine as FIG. 1;

FIG. 3 is a rear view of the grain elevator and devices of FIG. 2; and

FIG. 4 is an enlarged view of the grain elevator and jackshaft of FIG. 2, taken from a similar perspective as in FIG. 3; and

FIG. 5 is a cross-sectional view taken along a plane through the jackshaft of FIG. 2, from a similar perspective as in FIG. 3.

Like reference symbols in the various drawings indicate like elements.

### DETAILED DESCRIPTION

The following describes one or more example embodiments of the disclosed integrated jackshaft, as shown in the accompanying figures of the drawings described briefly above. Various modifications to the example embodiments may be contemplated by one of skill in the art.

The term “wheel,” as used herein, means any sprocket, pulley, or similar component that is configured to receive or transmit rotational power.

The term “input wheel,” as used herein, means any wheel mounted on a shaft that is configured to receive power from a chain, or belt, respectively, and to transmit that power to the shaft. A pulley or sprocket configured as an input wheel, may be referred to as an “input pulley,” or an “input sprocket.”

The term “output wheel,” as used herein, means any wheel that is configured to be supported on a shaft, to receive power from the shaft, and to transmit that power to a crop processing device via a chain or belt, respectively. A pulley or sprocket configured as an output wheel, may be referred to as an “output pulley,” or an “output sprocket.”

The term “crop processing device,” as used herein, means a device for processing crop material. Crop processing devices may be configured as harvesting heads (including reels, conveyors, augers, reciprocating knives, and other devices included in the harvesting heads), threshing rotors, threshing drums, straw walkers, crop spreaders, crop choppers, sieves, chaffers, fans, grain elevators, augers, cleaning shoes, and so on.

As noted above, agricultural combines may include various crop processing devices. Many combines utilize rotating jackshafts to transmit rotational power to these crop processing devices.

As discussed in detail herein, it may be useful to integrate a jackshaft into a grain elevator (or “elevator”) in order to power various crop processing devices other than the grain elevator. Such a jackshaft may be supported by a housing of the elevator, such that rotating the jackshaft moves grain within the elevator. For example, a sprocket may be attached to the jackshaft to drive a chain within the elevator.

An input wheel and an output wheel may also be attached to the jackshaft. The input wheel may be configured to receive rotational power from an engine of the combine. Accordingly, the jackshaft may receive rotational power from the engine, via the input wheel, to operate the grain elevator. The output wheel may be configured to provide rotational power to a crop processing device other than the elevator (e.g., a remotely located crop processing device). Accordingly, the rotational power received at the jackshaft via the input wheel may be directed, via the output wheel, to another crop processing device (other than the elevator).

In certain embodiments, a clean grain elevator may extend from a clean grain trough near the base of a combine toward a grain tank near the top of the combine. A shaft (i.e., a jackshaft) may be disposed at one end (e.g., an upper end) of the elevator. A drive sprocket (or other wheel) may be fixed to the shaft, such that rotating the shaft rotates the drive sprocket. A chain supporting various paddles or baskets may be seated on the drive sprocket, and on a driven sprocket at the other end (e.g., a lower end) of the elevator. Accordingly, rotation of the drive sprocket by the shaft may drive the chain to lift grain with the paddles or baskets, from the clean grain trough toward the grain tank.

In such an arrangement, the shaft may be rotationally driven by an engine (or other power source) of the combine, via a system of belts (or chains), and input and output wheels. For example, a first pulley may be mounted to the shaft such that rotation of the main drive member causes rotation of the shaft. The first pulley may be configured to receive power from an engine of the combine (e.g., may be connected by a belt to another pulley driven by the engine), such that the engine may drive rotation of the first pulley. In this way, the first pulley may receive power from the engine to rotate the shaft.

Additional pulleys (or other wheels) may also be attached to the shaft such that rotation of the shaft also causes the additional pulleys to rotate. In certain embodiments, one of the additional pulleys may be integrally formed with another pulley attached to the shaft, or may be mounted to the shaft using a hub of another pulley.

A belt (or chain) may be seated on the additional pulleys in order to transmit rotational power from these pulleys to other crop processing devices. In this way, for example, when the engine rotates the first pulley, the first pulley rotates the shaft. The rotation of the shaft drives rotation of the additional pulleys, and the rotation of the additional pulleys transmits power to various crop processing devices.

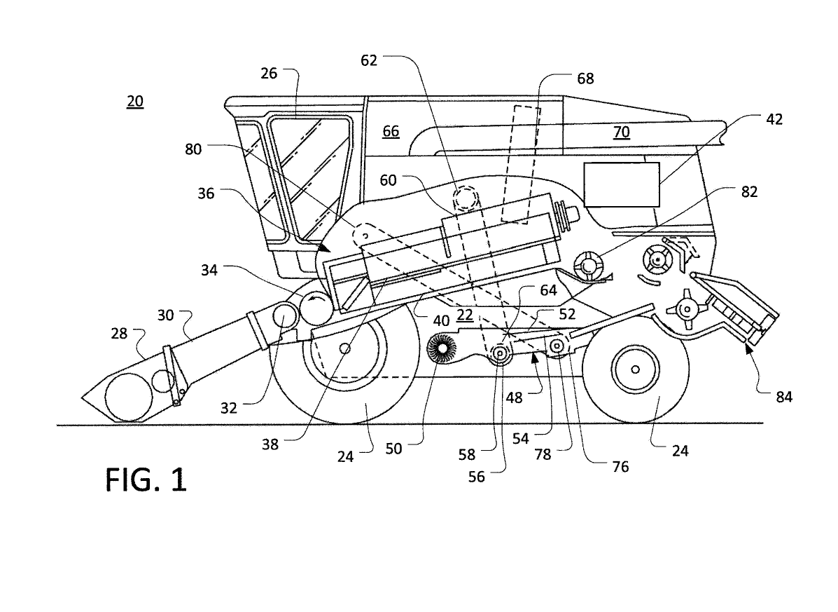

Referring now to FIG. 1, an example jackshaft and elevator arrangement may be implemented with respect to an example agricultural combine 20, or with respect to a variety of other agricultural combines. As used below, directional terms such as “front” or “forward” may refer to the forward direction of travel of combine 20, which is toward the left in FIG. 1. Likewise, directional terms such as “back” or “rear” may refer to the reverse direction of travel of the combine, which is toward the right in FIG. 1. The terms “transverse”, “lateral”, “side-to-side” or the like may refer to a generally horizontal direction that is at a right angle to the forward (or rearward) direction.

As depicted in FIG. 1, the example agricultural combine (or “combine”) 20 includes a chassis 22 with wheels 24. The wheels 24 are mounted to a chassis 22, and engage with the ground in order to propel the combine 20. A cab 26, also mounted to the chassis 22, houses an operator as well as various devices to control the combine 20. The wheels 24 and other devices of the combine 20 are powered by an internal combustion engine 42.

A header 28 is supported at the front of the combine 20 in order to cut and gather crop material from a field. The header 28 is supported by a feederhouse 30, which is pivotally mounted to the chassis at mount 32. The feederhouse 30 may include, for example, an inclined conveyor (not shown) for transport of cut crop material from the header 28 into the body of the combine 20.

After passing over a guide drum 34 or feed accelerator, the crop material from the feederhouse 30 reaches an axially oriented threshing device 36. (Other embodiments may include laterally oriented or other threshing devices (not shown).) In the embodiment depicted, threshing device 36 includes a rotor 38, on which various threshing elements (not shown) are mounted. The rotor 38 rotates above a grated or sieved concave 40, such that crop material passing between the threshing elements and the concave 40 is separated, at least in part, into grain and chaff (or other non-grain material).

Grain and chaff passing through the concave 40 fall (or are actively fed) into a cleaning shoe 48, for further cleaning. The cleaning shoe 48 includes a fan 50, for generating generally rearward air flow, as well as a sieve 52, and a chaffer 54. The sieve 52 and chaffer 54 are suspended from the chassis 22 by pivot arms (not shown) and are connected, respectively, to rocker arms (not shown) mounted to disks (or other devices). As the fan 50 blows air across and through the sieve 52 and the chaffer 54, rotation of the disks causes reciprocating motion of the sieve 52 and the chaffer 54, via movement of the rocker arms. The combination of this motion of the sieve 52 and the chaffer 54 with the air flow from the fan 50 generally causes the lighter chaff to be blown upward and rearward within the combine 20, while the heavier grain falls through the sieve 52 and the chaffer 54 and accumulates in a clean grain trough 56 near the base of the combine 20. An auger 58 within the trough 56 rotates to move the cleaned grain through the trough 56 to the lower end of a clean grain elevator 60 (shown in phantom lines in FIG. 1).

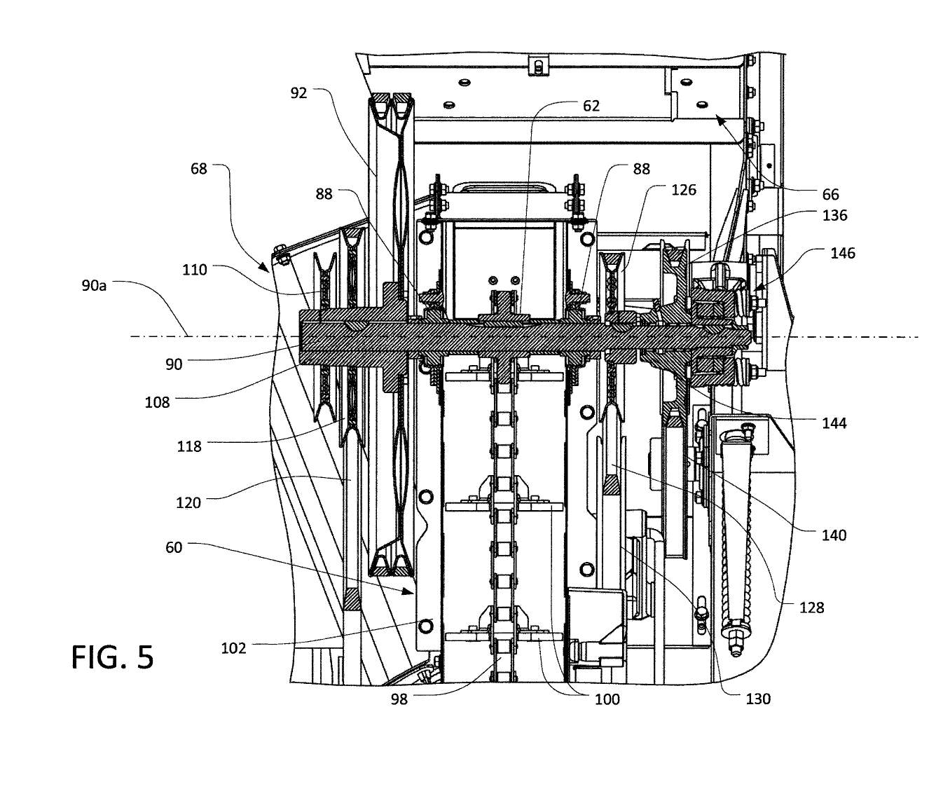

The elevator 60 includes a chain drive, with a chain (see FIG. 5) seated on upper and lower sprockets 62 and 64, respectively, and extending along the length of the elevator 60. Various paddles or baskets (not shown) are spaced at regular intervals along the chain such that when the sprockets 62 and 64 drive the chain, the paddles or baskets lift clean grain from the trough 56 towards a grain tank 66 for temporary storage. In the embodiment depicted, the elevator 60 lifts the clean grain only part of the distance between the trough 56 and the grain tank 66. At the top of the elevator 60, the clean grain is transferred from the elevator 60 to a loading auger 68, which further elevates the clean grain into the grain tank 66. (In such a configuration, the loading auger 68 may be viewed as a secondary grain elevator cooperating with the grain elevator 60. It will be understood that various other configurations are possible) The clean grain in grain tank 66 can be transferred from the tank 66 onto a grain wagon, trailer or truck (not shown) via a discharge chute 70.

Crop material that does not fall through the sieve 52 and the chaffer 54 into the clean grain trough and is not carried sufficiently far to the rear of the combine 20 by the air flow from the fan 50 falls into a tailings trough 76 housing a tailings auger 78. The tailings auger 78 rotates in order to convey the material to a tailings elevator 80. The tailings elevator 80 then conveys the crop material forward and upward for re-threshing (or other processing) by the various devices of the combine 20.

Crop material that reaches the rearward end of the rotor 38 without passing through the concave 40 is fed to a rethresher (not shown) or a throw drum 82, which throws lighter material (i.e., chaff) rearward while directing heavier material downward towards the tailings auger 78. Material thrown rearward by the throw drum 82 (or a rethresher) as well as chaff blown rearward by the fan 50 are conveyed into a straw chopper or various other devices for processing chaff. The resulting non-grain stream of crop material is then ejected from the rear of the combine 20, with a straw spreader 84 or other device spreading the material toward either side of the combine 20.

As also discussed below, various of the devices noted above (and other rotary devices of the combine 20) are rotationally powered by a system of drive members and conveyers. For example, an engine (not shown) of the combine 20 may drive the rotation of one or more powered drive members (not shown in FIG. 1), which may in turn drive the rotation of various rotating components and devices.

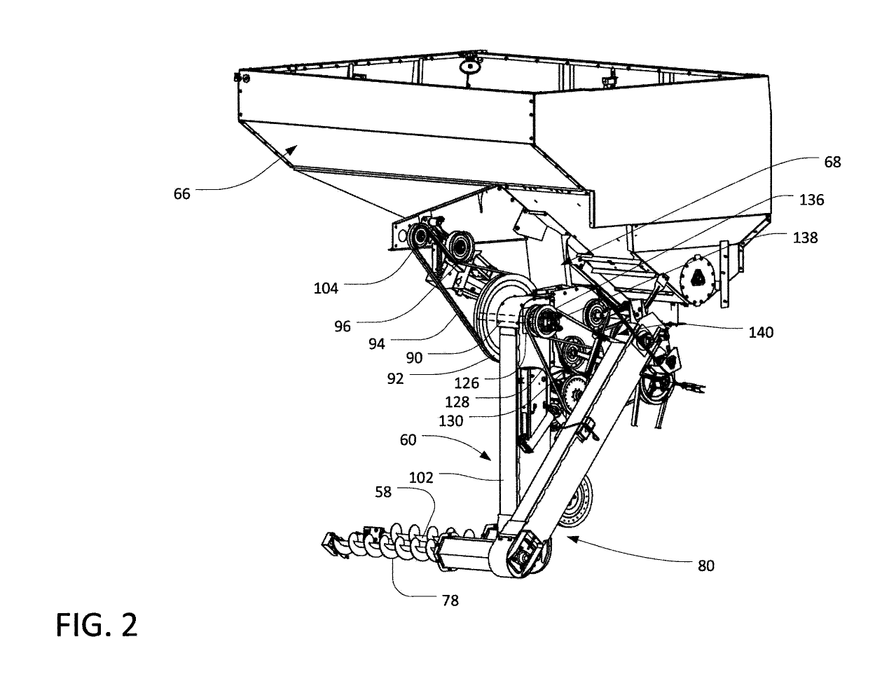

As explained in greater detail below, various of the devices noted above may be driven via a single jackshaft that is integrated with the elevator 60. Referring also to FIGS. 2-5, an integrated jackshaft 90 is mounted at the upper end of the clean grain elevator 60. Referring in particular to FIG. 5, the jackshaft 90 extends laterally across a housing 102 of the elevator 60, and is rotatably supported with respect to the housing 102 by various bearings 88. The upper sprocket 62 is fixedly and coaxially attached to the jackshaft 90 within the housing 102, and a chain 98 (i.e., other “elevator belt”) supporting various paddles 100 is seated on the sprocket 62. Accordingly, rotation of the jackshaft 90 about axis of rotation 90a causes the sprocket 62 also to rotate around axis of rotation 90a and thereby drives the paddles 100, via the chain 98, to carry grain upwards within the housing 102. The chain 98 is also seated on the lower sprocket 64 (see FIG. 1), such that the lower sprocket 64 rotates to support the chain 98. (Because the sprocket 62 rotates to drive the chain 98, the sprocket 62 may be referred to as a “drive sprocket.” Likewise, because the sprocket 64 is rotated by the chain 98, the sprocket 64 may be referred to as a “driven sprocket.”)

In the embodiment depicted, the jackshaft 90 is formed as a unitary or single-piece shaft. It will be understood that other integrated jackshafts need not necessarily exhibit unitary construction. For example, in certain embodiments, a single jackshaft formed from multiple pieces may be utilized in an integrated jackshaft assembly.

Still referring to FIGS. 2-5, in the combine 20, a pulley 92 is fixedly and coaxially attached to the jackshaft 90 on one side of the housing 102. Another pulley 104 is mounted remotely from the pulley 92, with two belts 94 seated on and extending between the main drive pulley 92 and the pulley 104. Accordingly, the pulley 92 (and the jackshaft 90) may be rotated around the axis of rotation 90a when the engine 42 (see FIG. 1) rotates the pulley 104.

As discussed in greater detail below, various output wheels (e.g., various additional pulleys) may also be attached to the jackshaft 90 such that the output wheels may also receive rotational power via the pulleys 104 and 92. The output wheels may be connected by various belts (or chains) to various input wheels for various remotely located crop processing devices. When the output wheels rotate, the belts may accordingly transmit rotational power from the output wheels to the crop processing devices.

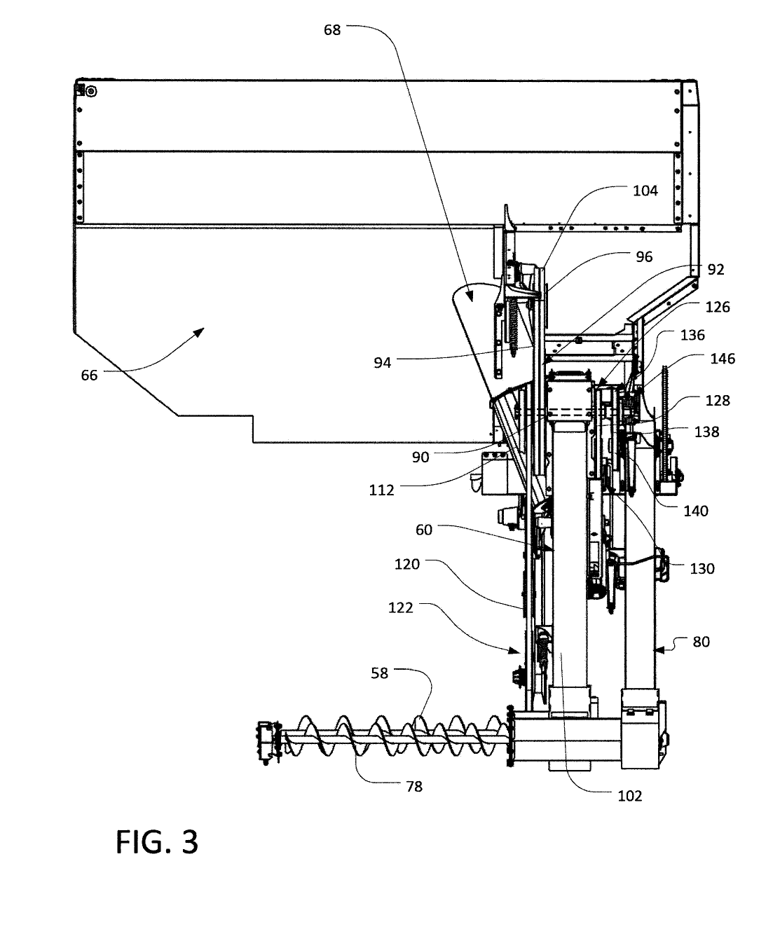

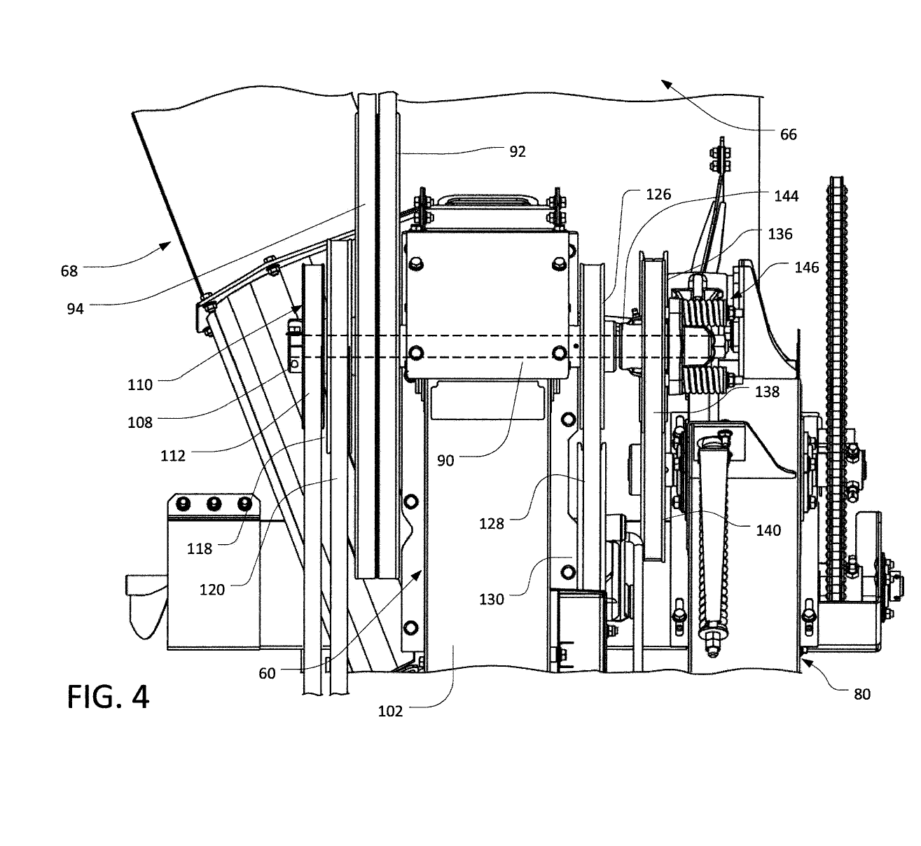

As depicted, the pulley 92 is attached to the jackshaft 90 via a hub 108 (see FIGS. 4 and 5) that is also fixedly and coaxially attached to the jackshaft 90. Various output wheels may also be attached to the jackshaft 90 via the hub 108. For example, in the combine 20, an output pulley 118 and an output pulley 110 are also fixedly and coaxially attached to the jackshaft 90 via the hub 108. A belt 120 extends between and is seated on the pulley 118 and an input pulley 122 for the cleaning shoe 48 (see, in particular, FIG. 3). The pulley 122 is attached to one or more rotating components of the cleaning shoe 48, such as a support disk for various rocker arms (not shown). As such, rotation of the pulley 118, via rotation of the jackshaft 90, causes the pulley 122 to rotate and thereby drives the rotation of various components of the cleaning shoe 48. Similarly, a belt 112 extends between and is seated on the pulley 110 and an input pulley (not shown) for the straw spreader 84. As such, rotation of the pulley 110, via rotation of the jackshaft 90, provides rotational power to the straw spreader 84.

Various output wheels may additionally (or alternatively) be attached to the jackshaft 90 independently of the hub 108. For example, in the embodiment depicted, output pulleys 126 and 136 are fixedly and coaxially attached to the jackshaft 90 on an opposite side of the housing 102 from the hub 108 and the pulleys 92, 110, and 118. A belt 128 extends between and is seated on the pulley 126 and an input pulley 130 for the loading auger 68. As such, rotation of the pulley 126, via rotation of the jackshaft 90, causes the pulley 130 to rotate and thereby drives the rotation of the loading auger 68. Similarly, a belt 138 extends between and is seated on the pulley 136 and an input pulley 140 for the tailings elevator 80. As such, rotation of the pulley 136, via rotation of the jackshaft 90, causes the pulley 140 to rotate and thereby drives operation of the elevator 80.

Other devices may also be included. For example, in the embodiment depicted, the output pulley 136 is attached to the jackshaft 90 via a hub 144 (see, e.g., FIGS. 4 and 5). A clutch device 146 engaged with the hub 144 may be configured to stall transmission of power between the pulleys 136 and 140 when the tailings elevator 80 stalls or plugs. In this way, for example, the clutch device 146 may act to prevent slippage of the belt 138 (or other belts of the depicted assembly).

As depicted in the figures, various tensioning pulleys (e.g., pulley 96, in FIG. 1) and other devices may also be included in the combine 20. In certain embodiments, these tensioning pulleys and other devices may, for example, support effective and efficient transmission of power via various belts (or chains) between various wheels. It will be understood that various configurations and combinations of tensioning pulleys and other devices may be possible, including configurations and combinations not depicted in the various figures.

It will further be understood that an integrated jackshaft arrangement, as contemplated by this disclosure, may be generally implemented with respect to various combines (not shown) other than those configured as the combine 20. Likewise, an integrated jackshaft arrangement may be implemented using different wheels and belts (or chains) than those depicted in the combine 20. Also, although certain crop processing devices of the combine 20 are specifically depicted as being driven by certain output wheels on the jackshaft 90, it will be understood that other devices (or other combinations of devices) may additionally (or alternatively) be driven by output wheels on the jackshaft 90 (or another integrated jackshaft). Further, although the jackshaft 90 is depicted as being structurally supported by the clean grain elevator 60, an integrated jackshaft assembly may be utilized with respect to other components of the combine 20, including other elevators.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, components, operations, or arrangements, but do not preclude the presence or addition of one or more other features, components, operations or arrangements.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Explicitly referenced embodiments herein were chosen and described in order to best explain the principles of the disclosure and their practical application, and to enable others of ordinary skill in the art to understand the disclosure and recognize many alternatives, modifications, and variations on the described example(s). Accordingly, various implementations other than those explicitly described are within the scope of the claims.

What is claimed is:

1. A jackshaft and grain elevator arrangement for an agricultural combine (20) driven by an internal combustion engine (42), the jackshaft arrangement comprising:
a grain elevator (60) with a housing (102), a drive sprocket (62) disposed within the housing, a driven sprocket (64) disposed within the housing, wherein a chain (98) disposed within the housing is wrapped around the drive sprocket (62) and the driven sprocket (64), and a plurality of paddles (100) are attached to the chain (68);
a shaft (90) extending through the drive sprocket (62), wherein the shaft (90) is fixed to the drive sprocket (62) to drive the drive sprocket (62) in rotation;
a first pulley (92) disposed outside the housing (102), wherein the first pulley (92) is fixed to the shaft (90) to receive power from the internal combustion engine and is configured to transmit that power to the shaft (90); and
a second pulley (110) disposed outside the housing, wherein the second pulley is fixed to the shaft to receive power from the shaft and is configured to transmit that power to a first crop processing device.

2. The jackshaft and grain elevator arrangement of claim 1, wherein the first pulley is disposed on the shaft between the second pulley and the grain elevator.

3. The jackshaft and grain elevator arrangement of claim 1, wherein the grain elevator is disposed on the shaft between the first pulley and the second pulley.

4. The jackshaft and grain elevator arrangement of claim 1, wherein the first crop processing device is selected from the group consisting of a cleaning shoe (48), a straw spreader (84), a loading auger (68), and a tailings elevator (80).

5. The jackshaft and grain elevator arrangement of claim 4, further comprising a third pulley (126) disposed outside the housing, wherein the third pulley is attached to the shaft to receive power from the shaft and transmit that power to a second crop processing device.

6. The jackshaft and grain elevator arrangement of claim 5, wherein the second crop processing device is selected from the group consisting of a cleaning shoe (48), a straw spreader (84), a loading auger (68), and a tailings elevator (80).

7. The jackshaft and grain elevator arrangement of claim 1, wherein the shaft is supported for rotation on bearings (88), and further wherein the bearings are fixed to opposing sides of the housing.

8. The jackshaft and grain elevator arrangement of claim 1, wherein the shaft, the first pulley, the second pulley, and the drive sprocket all rotate about a common rotational axis (90a).

9. A jackshaft and grain elevator arrangement for an agricultural combine (20) driven by an internal combustion engine (42), the jackshaft arrangement comprising:
a grain elevator (60) with a housing (102), a drive sprocket (62) disposed within the housing, a driven sprocket (64) disposed within the housing, and a chain (98) disposed within the housing, wherein the chain is wrapped around the drive sprocket and the driven sprocket, and a plurality of paddles (100) or buckets are attached to the chain (68);
a shaft extending through the drive sprocket wherein the shaft is fixed to the drive sprocket to drive the drive sprocket in rotation;
an input wheel (92) disposed outside the housing, wherein the input wheel is attached to the shaft to receive power from the internal combustion engine and transmit that power to the shaft; and
a first output wheel (110) disposed outside the housing, wherein the first output wheel is attached to the shaft to transmit power from the shaft to a crop processing device.

10. The jackshaft arrangement of claim 9, wherein the input wheel is disposed on the shaft between the first output wheel and the elevator.

11. The jackshaft and grain elevator arrangement of claim 9, wherein the elevator is disposed on the shaft between the input wheel and the first output wheel.

12. The jackshaft and grain elevator arrangement of claim 9, wherein the crop processing device is selected from the group consisting of a cleaning shoe (48), a straw spreader (84), a loading auger (68), and a tailings elevator (80).

13. The jackshaft and grain elevator arrangement of claim 12, further comprising a third pulley (126) disposed outside the housing, wherein the third pulley is attached to the shaft to receive power from the shaft and transmit that power to a second crop processing device.

14. The jackshaft and grain elevator arrangement of claim 13, wherein the second crop processing device is selected from the group consisting of a cleaning shoe (48), a straw spreader (84), a loading auger (68), and a tailings elevator (80).

15. The jackshaft and grain elevator arrangement of claim 9, wherein the shaft is supported for rotation on bearings (88), and further wherein the bearings are fixed to opposing sides of the housing.

16. The jackshaft and grain elevator arrangement of claim 9, wherein the shaft, the drive sprocket, the input wheel, and the first output wheel all rotate about a common rotational axis (90a).
